(19) United States
(12) Patent Application Publication
(10) Pub. No.: US 2025/0102029 A1
(43) Pub. Date: Mar. 27, 2025

(54) BRAKE DISC WITH NICKEL-FREE STEEL LAYER AND METHOD FOR MAKING A BRAKE DISC

(71) Applicant: BREMBO S.p.A., Curno (Bergamo) (IT)

(72) Inventors: Simone BIONDO, Curno (Bergamo) (IT); Stefano MEDICI, Curno (Bergamo) (IT); Francesco Andrea BRESCIANI, Curno (Bergamo) (IT)

(73) Assignee: BREMBO S.p.A., Curno (Bergamo) (IT)

(21) Appl. No.: 18/722,751

(22) PCT Filed: Dec. 13, 2022
(86) PCT No.: PCT/IB2022/062125

§ 371 Date: Jun. 21, 2024

(30) Foreign Application Priority Data
Dec. 23, 2021 (IT) 102021000032384

(51) Int. Cl. F16D 65/12; C22C 38/02; C22C 38/04; C22C 38/08; C22C 38/18; F16D 65/02

(52) U.S. Cl. CPC F16D 65/127; C22C 38/02; C22C 38/04; C22C 38/08; C22C 38/18; F16D 65/125; F16D 2065/132; F16D 2200/0013; F16D 2200/0021; F16D 2250/0046

(57) ABSTRACT

Provided is a brake disc for a disc brake having a braking band made of gray cast iron or steel, provided with two opposite braking surfaces, each of which defines at least partially one of two main faces of the brake disc. The brake disc is provided with a base layer composed of a totally nickel-free steel that covers at least one of the two opposite braking surfaces of the braking band. The totally nickel-free steel of the base layer is composed of 10% to 15% chromium (Cr), at most 1% silicon (Si), at most 4% manganese (Mn), 0.16% to 0.5% carbon, and iron (Fe) as a balance.

### FIELD OF APPLICATION

The present invention relates to a method for manufacturing a brake disc, and to a brake disc for disc brakes.

### BACKGROUND ART

A brake disc of a disc braking system of a vehicle comprises an annular structure, or braking band, and a central fixing element, known as the bell, by means of which the disc is fixed to the rotating part of a vehicle suspension, e.g., a hub. The braking band is provided with opposite braking surfaces suitable for cooperating with friction elements (brake pads), housed in at least one caliper body placed straddling such a braking band and integral with a non-rotating component of the vehicle suspension. The controlled interaction between the opposing brake pads and the contrasting braking surfaces of the braking band results, by friction, in a braking action which allows the deceleration or stopping of the vehicle.

The brake disc is generally made of gray cast iron or steel. Indeed, this material allows obtaining good braking performance (especially in terms of wear containment) at a relatively low cost. Discs made of carbon or carbo-ceramic materials offer much higher performance, but at a much higher cost.

The limits of traditional discs, made of cast iron or steel, are related to excessive wear. As for the discs made of gray cast iron, another very negative aspect is related to excessive surface oxidation, resulting in the formation of rust. This aspect impacts both the performance of the brake disc and the appearance thereof because the rust on the brake disc is aesthetically unacceptable for users. Attempts have been made to tackle such problems by providing discs made of gray cast iron or steel with a protective coating. The protective coating, on the one hand, serves to reduce disc wear, and on the other, to protect the gray cast iron base from surface oxidation, thereby preventing the formation of a layer of rust. However, the protective coatings currently available and applied on discs, while offering resistance to wear, are subject to flaking which causes the detachment thereof from the disc itself.

A protective coating of this type is described, for example, in U.S. Pat. No. 4,715,486, related to a low-wear disc brake. The disc, made in particular of cast iron, has a coating made of a particle material deposited on the disc by a high kinetic energy impacting technique. According to a first embodiment, the coating contains from 20% to 30% tungsten carbide, 5% nickel, and the remaining part of a mixture of chromium and tungsten carbides.

In the case of application of the coating with flame spray techniques, a cause for the detachment of the traditional protective coatings from discs made of aluminum or aluminum alloy is the presence of free carbon in the protective coating. Such a phenomenon also affects discs made of gray cast iron or steel.

A solution to the aforesaid problems was suggested by the same Applicant in international application WO2014/097187 as for discs made of gray cast iron or steel. It consists in making a protective coating on the braking surfaces of a disc brake, obtained by depositing a material in particle form composed of 70 to 95% by weight of tungsten carbide, 5% to 15% by weight of cobalt, and 1% to 10% by weight of chromium. The deposition of the material in particle form is obtained by means of HVOF (High-Velocity Oxygen Fuel) or HVAF (High-Velocity Air Fuel) or KM (Kinetic Metallization) techniques.

More in detail, according to the solution offered in WO2014/097187, the combination of the HVOF, HVAF, or KM deposition technique and the chemical components used for forming the coating allows obtaining a protective coating provided with high bond strength, which ensures a high degree of anchoring on gray cast iron or steel. The aforesaid solution allows significantly reducing the protective coating flaking phenomena found in the previous known technique, but not eliminating them completely. Indeed, even in discs provided with a protective coating made according to WO2014/097186, flaking and sagging of the protective coating continue to occur-albeit less frequently than in the previous known technique.

The aforesaid flaking and sagging may contribute in particular to the release by rubbing of particles of nickel, which metal greatly contributes to sensitization phenomena in the population.

However, in the specific field of steel production for brake discs, the presence of nickel is considered essential to date, because it increases the strength and toughness of steel. Furthermore, nickel increases the resistance of steel to oxidation and corrosion, but more importantly, nickel increases the abrasive resistance of steel and the heat resistance of that steel, which aspects are highly relevant to the stresses to which brake discs are subjected in use. Therefore, to date, the presence of nickel is considered an essential element in manufacturing a cast iron or steel brake disc.

However, taking into account the advantages in terms of wear resistance ensured by the protective coatings and the simultaneous need to maintain the presence of nickel in the composition of the brake disc, the need is strongly felt in the field to solve the drawbacks mentioned above with reference to the prior art.

In particular, the need is felt to have gray cast iron or steel discs capable of reducing the release of nickel particles, but at the same time capable of ensuring adequate or equivalent thermal and mechanical performance, typical of the brake discs of the prior art, including high resistance to disc wear and reliability over time.

According to a further aspect, the need is also felt to manufacture steel discs with less consumption of resources required for production (and thus lower cost as well), while maintaining an adequate coating hardness and a reduced (or even absent) release of nickel particles at the same time.

### DISCLOSURE OF THE INVENTION

The need for brake discs capable of reducing the release of nickel particles but ensuring adequate or equivalent thermal and mechanical performance at the same time is met by a brake disc and by a method for manufacturing a brake disc according to the appended independent claims.

### DESCRIPTION OF THE DRAWINGS

Further features and advantages of the present invention will become more comprehensible from the following description of preferred embodiments thereof, given by way of non-limiting examples, in which:

FIG. 1 shows a top plan view of a disc brake according to an embodiment of the present invention;

FIG. 2 shows a section view of the disc in FIG. 1 taken along section line II-II indicated therein according to an embodiment of the present invention;

FIG. 3 shows a section view of the disc in FIG. 1 taken along section line II-II indicated therein according to a further embodiment of the present invention;

FIG. 4 shows a section view of a half-portion of a braking band according to an embodiment of the present invention;

FIG. 5 shows a section view of a half-portion of a braking band according to a second embodiment of the present invention;

FIG. 6 shows a section view of a half-portion of a braking band, according to a third embodiment of the present invention;

FIG. 7 shows a section view of a half-portion of a braking band according to a fourth embodiment of the present invention;

FIG. 8 shows a section view of a half-portion of a braking band according to a fifth embodiment of the present invention;

FIG. 9 shows a section view of a half-portion of a braking band according to a sixth embodiment of the present invention;

FIG. 10 shows a section view of a half-portion of a braking band according to a seventh embodiment of the present invention.

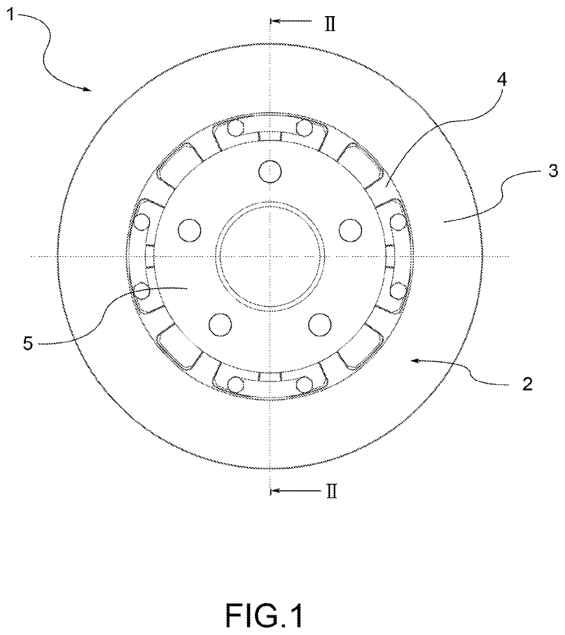

The elements or parts of elements common to the embodiments described below will be indicated by the same reference numerals.

### DETAILED DESCRIPTION

With reference to the aforesaid figures, reference numeral 1 globally indicates a brake disc according to the present invention.

In the present disclosure, where numerical percentage ranges are given, the extremes of such ranges are always understood to be comprised unless otherwise specified.

According to a general embodiment of the invention, shown in the accompanying figures, the brake disk 1 comprises a braking band 2, provided with two opposite braking surfaces 2a and 2b, each of which at least partially defines one of the two main faces of the disc.

The braking band 2 is made of gray cast iron or steel.

Preferably, the braking band 2 is made of gray cast iron. In particular, the entire disc is made of gray cast iron. Therefore, in the following description, reference will be made to a disc made of gray cast iron, without however excluding the possibility that it is made of steel.

The disc 1 is provided with a base layer 30, which covers at least one of the two braking surfaces 2a, 2b of the braking band and is preferably made in direct contact with such braking surfaces 2a, 2b.

According to an aspect of the present invention, such base layer 30 is composed of steel having a nickel content lower than or at most equal to 15%.

According to a further f aspect of the present invention, such a base layer 30 is composed of steel having a nickel content lower than or at most equal to 7.5%, even more preferably lower than or at most equal to 5%.

According to a further aspect of the present invention, layer 30 is totally nickel-free. This allows limiting, if not even avoiding, the dispersion of nickel particles during the service life of the brake disc 1.

In general, in the present disclosure, when reference is made to phrases such as “nickel-free” or “free of nickel” or the like, it is meant exactly the total absence of nickel but also an absence of nickel minus a small amount of nickel which may be present because of residual traces or impurities due to the manufacturing process, but still amounts of nickel less than 1% or possibly at most strictly less than 5%, for any layer.

Furthermore, according to the invention, the steel of the base layer 30 is composed of 10% to 15% chromium Cr, at most 1% silicon Si, at most 4% manganese Mn, between 0.16% and 0.5% of carbon C, and for the balance of iron Fe, that is, for the remaining percentage by weight of iron. This allows martensitic steel with no nickel content to be made.

Preferably, the carbon C content of the base layer steel is comprised between 0.16 and 0.25%.

Furthermore, in an extremely advantageous manner, the aforesaid composition allows using a small percentage of carbides possibly included in the steel, without reducing the hardness of the possible coating (described in greater detail later in the text).

According to a preferred variant, the chromium (Cr) content in the steel of the base layer 30 is comprised between 11% and 14%, extremes included.

It is apparent that those skilled in the art know what is meant when referring to percentages of nickel content or any other component of the steel alloy or cast iron. For example, reference is generally made to the mass percent content compared to the total alloy content. Therefore, in the remainder of the present disclosure, particular calculations of percentages will be specified only should they deviate from the definition given above; where not specified, the indicated percentages should be considered as understood by those skilled in the art.

According to a variant of the invention, e.g., shown in FIG. 5, the base layer 30 also is composed of one or more carbides included in the nickel-free steel. Such an inclusion is achieved by means of techniques known to those skilled in the art of inclusion of carbides in steel, e.g., the carbides are dissolved in the alloy.

Preferably, the one or more included carbides comprise at least one carbide selected from the group comprising: tungsten carbide (WC), chromium carbide (preferably, but not limited to, Cr3C2), niobium carbide (NbC), titanium carbide (TiC). It is apparent that more than one carbide may be present, chosen from the aforesaid group or all the carbides in the present group may be present.

The one or more included carbides comprise at least one carbide selected from the group comprising: tungsten carbide (WC), chromium carbide (e.g., Cr3C2), niobium carbide (NbC), titanium carbide (TiC).

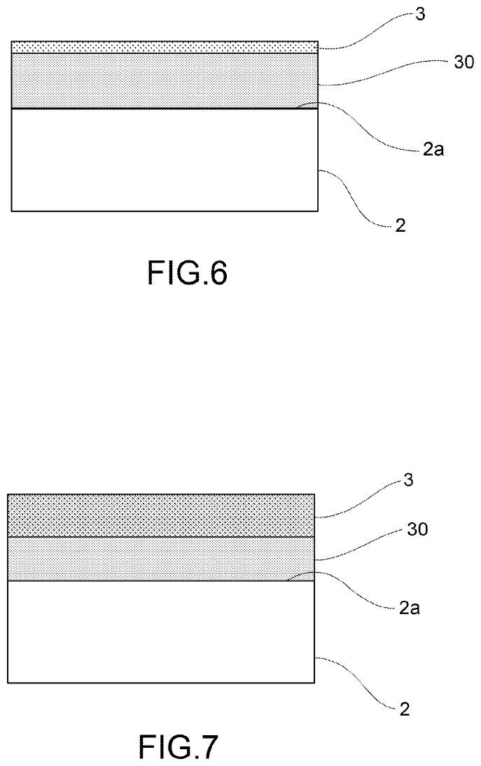

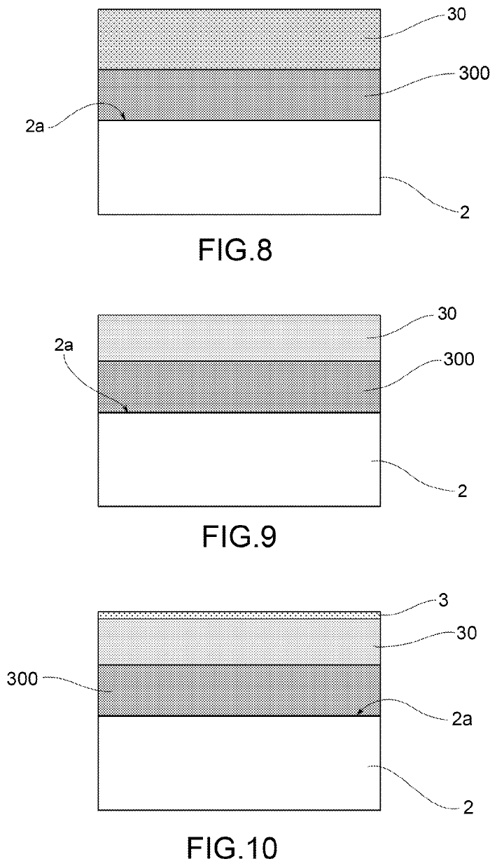

According to an advantageous embodiment, e.g., shown in FIG. 6, the brake disc 1 comprises a surface protective coating 3 which covers the base layer 30 at least on the side of one of the two braking surfaces 2a, 2b of the braking band. Such a surface protective coating 3 is provided on one side of the base layer 30 which does not face the braking surface 2a, 2b. Furthermore, the surface protective coating 3 is composed of of at least one carbide or more carbides in particle form which may be deposited by the Thermal Spray deposition technique, e.g., by the HVOF (High-Velocity Oxy-Fuel) technique, or by the HVAF (High-Velocity Air Fuel) technique, or by the APS (Atmosphere Plasma Spray) technique, or by a Cold Spray deposition technique, e.g., by the KM (Kinetic Metallization) technique, or by a laser beam deposition technique, e.g., by the LMD (Laser Metal Deposition) technique, or by the HSLC (High-Speed Laser Cladding) technique, or by the EHLA (Extreme High-Speed Laser Application) technique, or by the TSC (Top Speed Cladding) technique.

The surface protective coating 3 is thus obtained by depositing one or more carbides in particle form directly on the disc 1 even by HVOF technique, or by HVAF (High-Velocity Air Fuel) technique by KM (Kinetic Metallization) technique, preferably tungsten carbide (WC) or chromium carbide (e.g., Cr3C2) or niobium carbide (NbC) or titanium carbide (TiC).

According to a further variant, the surface protective coating 3 is composed of of steel having a nickel content of less than or at most equal to 15% or less than or at most equal to 7.5%, or less than or at most equal to 5%, or even more preferably totally nickel-free, and one or more carbides included in the steel. In this variant, in other words, over the cast iron band are joined, in the order given, the base layer 30 made of nickel-free steel and, over the base layer 30, a surface protective coating 3 consisting of the aforesaid steel and one or more carbides included in the steel.

The presence of carbides either deposited on the surface or included in the steel substantially or totally nickel-free allows imparting adequate mechanical strength and wear resistance, so as to make up for the shortage or total lack of nickel in the steel.

According to a variant, the surface protective coating 3 is composed of one or more of the following carbides: tungsten carbide (WC), niobium carbide (NbC), chromium carbide (e.g., Cr3C2), titanium carbide (TiC). Preferably, such a surface protective coating 3 is obtained by depositing on the base layer 30 one or more carbides in particle form by a Thermal Spray deposition technique, e.g., by the HVOF (High-Velocity Oxy-Fuel) technique, or by the HVAF (High-Velocity Air Fuel) technique, or by the APS (Atmosphere Plasma Spray) technique, or by a Cold Spray deposition technique, e.g., by the KM (Kinetic Metallization) technique, or by a laser beam deposition technique, e.g., by the LMD (Laser Metal Deposition) technique, or by the HSLC (High-Speed Laser Cladding) technique, or by the EHLA (Extreme High-Speed Laser Application) technique, or by the TSC (Top Speed Cladding) technique. It is thus apparent that more than one carbide may be present, chosen from the aforesaid group, or all the carbides present in this group.

According to an advantageous embodiment, the surface protective coating 3 is composed of chromium carbide (e.g., Cr3C2) and titanium carbide (TiC).

According to a variant, the surface protective coating 3 is composed of at least one metal oxide or mixture of metal oxides or mixture of metals and ceramic materials, preferably a mixture of Al2O3 aluminum oxides, or a mixture of Al2O3 and Fe—Cr intermetal matrix, e.g., Fe28Cr.

According to an advantageous variant, the surface protective coating 3 is composed of one or more of the following carbides: tungsten carbide (WC), niobium carbide (NbC), chromium carbide (e.g., Cr3C2), titanium carbide (TiC), mixed with a mixture of metal oxides or mixed with a mixture of metals and ceramic materials, preferably with a mixture of aluminum oxides Al2O3, or a mixture of Al2O3 and intermetal matrix Fe—Cr, e.g., Fe28Cr.

It is apparent that the oxides or mixtures of oxides, or the metals or mixtures of metals and ceramic materials, or the mixtures of carbides and metal oxides described above are preferably deposited by the same deposition techniques of carbides in particle form as described earlier and in the present disclosure.

Preferably, the thickness of the surface protective coating 3 is between 30 μm and 150 μm, and preferably between 50 μm and 90 μm.

Preferably, moreover, the steel of the base layer 30 comprises at most 4% manganese (Mn), even more preferably, the manganese content is between 0.5 and 4%, extremes included, so as to compensate at least partially for the lack of steel alloy properties generally conferred by the presence of nickel, increasing mechanical strength.

Preferably, the thickness of the base layer 30 is comprised between 20 μm and 300 μm, and preferably equal to 90 μm.

According to a variant of the invention, to compensate for the low amount or complete absence of nickel and obtaining adequate performance for a brake disc, the steel of the base layer 30 has a molybdenum content between 0.5% and 10%, even more preferably between 0.5% and 4.5%, extremes included, and a manganese content between 0.5% and 5%. The presence of molybdenum and manganese in the aforesaid percentages allows obtaining adequate corrosion resistance and at the same time adequate mechanical strength.

According to an embodiment, an intermediate layer 300 of nickel-free steel is interposed between the base layer 30 and at least one of the two braking surfaces 2a, 2b of the braking band 2.

According to an embodiment, the intermediate layer 300 comprises nickel-free steel composed of 10% to 15% chromium (Cr), at most of 1% silicon (Si), at most of 4% manganese (Mn), between 0.16% and 0.5% carbon (C) and for the balance of iron (Fe). Preferably, the carbon (C) content is between 0.16% and 0.25%.

According to a variant, an intermediate layer 300 of steel comprising nickel, preferably with a nickel content of more than 5% if the base layer 30 is totally nickel-free, or, even more preferably with a nickel content at least equal to 5%, and even more preferably with a nickel content at least equal to 5% and lower than 15%, is interposed between the base layer 30 and at least one of the two braking surfaces 2a, 2b of the braking band 2.

According to an embodiment, the intermediate layer 300 comprises steel with a nickel content at most equal to 15% or equal to 15%.

According to an embodiment, the intermediate layer 300 comprises steel with a nickel content at most equal to 7.5% or equal to 7.5%.

The presence of the intermediate layer 300 allows obtaining a disc with adequate mechanical features, but at the same time with reduced environmental impact, by virtue of the presence of the base layer 30.

According to an embodiment, the intermediate layer 300 comprises steel composed of 10% to 15% chromium (Cr), at most 1% silicon (Si), at most 4% manganese (Mn), between 0.16% and 0.5% carbon (C) and for the remainder of iron (Fe). Preferably, the carbon content (C) of the steel of the intermediate layer 300 is between 0.16% and 0.25%, extremes included.

According to an embodiment, the surface protective coating 3 comprises steel composed of 10% to 15% chromium (Cr), at most 1% silicon (Si), at most 4% manganese (Mn), between 0.16% and 0.5% carbon (C) and for the remainder of iron (Fe), preferably without nickel.

Preferably, the carbon content (C) of the surface protective coating steel is between 0.16% and 0.25%, extremes included.

According to an embodiment, an auxiliary ferritic-nitrocarburized layer or an auxiliary ferroalumination layer is interposed between one of the two braking surfaces 2a, 2b of the braking band and the base layer 30, or between one of the two braking surfaces 2a, 2b of the braking band and the intermediate layer 300, or between the base layer 30 and the surface protective coating 3, or between the intermediate layer 300 and the base layer 30.

According to an embodiment, an auxiliary ferritic-nitrocarburized layer or an auxiliary ferroalumination layer is interposed between one of the two braking surfaces 2a, 2b of the braking band and the base layer 30, or between one of the two braking surfaces 2a, 2b of the braking band and the intermediate layer 300, or between the base layer 30 and the surface protective coating 3, or between the intermediate layer 300 and the base layer 30.

For disclosure simplicity, the brake disc 1 will now be described along with the method according to the present invention. The brake disc 1 is preferably, but not necessarily, manufactured by the method according to the invention described below.

According to a first aspect of the present invention, a general implementation of the method according to the invention comprises the following operating steps:
a) providing a brake disc, comprising a braking band provided with two opposite braking surfaces 2a, 2b, each of which defines at least partially one of the two main faces of the disc, the braking band being made of gray cast iron or steel;
b) depositing a layer of steel comprising at most 15% of nickel, preferably by a laser deposition technique, e.g., Laser Metal Deposition or Extreme High-Speed Laser Material Deposition or by Thermal Spray deposition technique, or by Cold Spray deposition technique, to form the base layer 30;
c) optionally depositing over said base layer 30 a material in particle form composed of tungsten carbide (WC) or niobium carbide (NbC) or titanium carbide (Tic) or possibly chromium carbide by a Thermal Spray deposition technique, e.g., by the HVOF (High-Velocity Oxy-Fuel) technique, or by the HVAF (High-Velocity Air Fuel) technique, or by the APS (Atmosphere Plasma Spray) technique or by the Cold Spray deposition technique, e.g., by the KM (Kinetic Metallization) technique, or by a laser beam deposition technique, e.g., by the LMD (Laser Metal Deposition) technique, or by the HSLC (High-Speed Laser Cladding) technique, or by the EHLA (Extreme High-Speed Laser Application) technique, or by the TSC (Top Speed Cladding) technique, forming a surface protective coating 3 which covers at least one of the two braking surfaces of the braking band, for example which covers the base layer 30, preferably at least over the entire surface of one of the two braking surfaces 2a, 2b of the braking band.

According to a second aspect of the present invention, a further general implementation of the method according to the invention comprises the following operating steps:
a) providing a brake disc, comprising a braking band provided with two opposite braking surfaces 2a, 2b, each of which defines at least partially one of the two main faces of the disc, the braking band being made of gray cast iron or steel;
b) depositing a layer of totally nickel-free steel, preferably by a laser deposition technique, e.g., Laser Metal Deposition or Extreme High-Speed Laser Material Deposition or by the Thermal Spray deposition technique, or by the Cold Spray deposition technique, to form the base layer 30;
c) optionally depositing over said base layer 30 a material in particle form composed of tungsten carbide (WC) or niobium carbide (NbC) or titanium carbide (Tic) or possibly chromium carbide by a Thermal Spray deposition technique, e.g., by the HVOF (High-Velocity Oxy-Fuel) technique, or by the HVAF (High-Velocity Air Fuel) technique, or by the APS (Atmosphere Plasma Spray) technique or by the Cold Spray deposition technique, e.g., by the KM (Kinetic Metallization) technique, or by a laser beam deposition technique, e.g., by the LMD (Laser Metal Deposition) technique, or by the HSLC (High-Speed Laser Cladding) technique, or by the EHLA (Extreme High-Speed Laser Application) technique, or by the TSC (Top Speed Cladding) technique, forming a surface protective coating 3 which covers at least one of the two braking surfaces of the braking band, for example which covers the base layer 30, preferably at least over the entire surface of one of the two braking surfaces 2a, 2b of the braking band.

According to a third aspect of the present invention, a further general implementation of the method according to the invention comprises the following operating steps:
a) providing a brake disc, comprising a braking band provided with two opposite braking surfaces 2a, 2b, each of which defines at least partially one of the two main faces of the disc, the braking band being made of gray cast iron or steel;
a1) after step a), depositing on at least one of the two opposite braking surfaces 2a, 2b, an intermediate layer 300 composed of nickel-free steel;
b) after step a1) depositing a layer of totally nickel-free steel, preferably by a laser deposition technique, e.g., Laser Metal Deposition or Extreme High-Speed Laser Material Deposition or by the Thermal Spray deposition technique, or by the Cold Spray deposition technique, to form the base layer 30;
c) optionally depositing over said base layer 30 a material in particle form composed of tungsten carbide (WC) or niobium carbide (NbC) or titanium carbide (Tic) or chromium carbide by a Thermal Spray deposition technique, e.g., by the HVOF (High-Velocity Oxy-Fuel) technique, or by the HVAF (High-Velocity Air Fuel) technique, or by the APS (Atmosphere Plasma Spray) technique or by the Cold Spray deposition technique, e.g., by the KM (Kinetic Metallization) technique, or by a laser beam deposition technique, e.g., by the LMD (Laser Metal Deposition) technique, or by the HSLC (High-Speed Laser Cladding) technique, or by the EHLA (Extreme High-Speed Laser Application) technique, or by the TSC (Top Speed Cladding) technique, forming a surface protective coating 3 which covers at least one of the two braking surfaces of the braking band, for example which covers the base layer 30, preferably at least over the entire surface of one of the two braking surfaces 2a, 2b of the braking band.

According to an advantageous embodiment, step a1) includes depositing an intermediate layer 300 composed of nickel-free steel and from 10% to 15% chromium (Cr), at most 1% silicon (Si), at most 4% manganese (Mn), between 0.16% and 0.5% carbon (C), preferably between 0.16% and 0.25% carbon (C), extremes included, and for the balance of iron (Fe). According to a further aspect of the present invention, a further general implementation of the method according to the invention comprises the following operating steps:
a) providing a brake disc 1, comprising a braking band 2 provided with two opposite braking surfaces 2a, 2b, each of which defines at least partially one of the two main faces of the disc, the braking band being made of gray cast iron or steel;
b) depositing a base layer 30 composed of totally nickel-free steel, and from 10% to 15% chromium (Cr), at most of 1% silicon (Si), at most of 4% manganese (Mn), between 0.16% and 0.5% carbon (C), preferably between 0.16% and 0.25%, and for the remainder of iron (Fe).

According to a further aspect of the present invention, a general implementation of the method according to the invention comprises the following operating steps:
a) providing a brake disc, comprising a braking band provided with two opposite braking surfaces 2a, 2b, each of which defines at least partially one of the two main faces of the disc, the braking band being made of gray cast iron or steel;
a1) after step a), depositing on at least one of the two opposite braking surfaces 2a, 2b, an intermediate layer 300 composed of steel comprising nickel, preferably according to the features described in the previous paragraphs of the present disclosure;
b) after step a1) depositing a layer of totally nickel-free steel, preferably by a laser deposition technique, e.g., Laser Metal Deposition or Extreme High-Speed Laser Material Deposition or by the Thermal Spray deposition technique, or by the Cold Spray deposition technique, to form the base layer 30;
c) optionally depositing over said base layer 30 a material in particle form composed of tungsten carbide (WC) or niobium carbide (NbC) or titanium carbide (Tic) or possibly chromium carbide by a Thermal Spray deposition technique, e.g., by the HVOF (High-Velocity Oxy-Fuel) technique, or by the HVAF (High-Velocity Air Fuel) technique, or by the APS (Atmosphere Plasma Spray) technique or by the Cold Spray deposition technique, e.g., by the KM (Kinetic Metallization) technique, or by a laser beam deposition technique, e.g., by the LMD (Laser Metal Deposition) technique, or by the HSLC (High-Speed Laser Cladding) technique, or by the EHLA (Extreme High-Speed Laser Application) technique, or by the TSC (Top Speed Cladding) technique, forming a surface protective coating 3 which covers at least one of the two braking surfaces of the braking band, for example which covers the base layer 30, preferably at least over the entire surface of one of the two braking surfaces 2a, 2b of the braking band.

Furthermore, in the aforesaid general implementation variants of the method according to the present invention, the method preferably includes the further steps that will be described below.

Preferably, in step c) tungsten carbide (WC) or niobium carbide (NbC) or titanium carbide (Tic) or possibly Chromium Carbide is dispersed in a metal matrix. According to a preferred embodiment, in step c), the material in particle form is composed of chromium carbide and titanium carbide.

Advantageously, the brake disc is provided with a portion suitable for fixing the disc to a vehicle, consisting of an annular portion 4 which is arranged centrally to the disc 1 and concentric to the braking band 2. The fixing portion 4 supports the connection element 5 to the wheel hub (i.e., the bell). The bell may be made in one piece with the annular fixing portion (as shown in the accompanying figures) or may be made separately and then fixed by means of appropriate connection elements to the fixing portion.

The annular fixing portion 4 may be made of the same material as the braking band, that is, of gray cast iron, or another suitable material. The bell 5 may also be made of gray cast iron or other appropriate material. In particular, the entire disc (that is, the braking band, the fixing portion, and the bell) may be made of gray cast iron.

Preferably, the braking band 2 is made by casting. Similarly, when the fixing portion and/or the bell are made of gray cast iron, they may be produced by casting.

The annular fixing portion may be made in a single body with the braking band (as shown in the accompanying figures) or may be made as a separate body, mechanically connected to the braking band.

The HVOF, HVAF or KM, or LMD or HSLC techniques are three deposition techniques known to those skilled in the art and therefore they will not be described in detail.

HVOF (High-Velocity Oxygen Fuel) is a powder spray deposition technique which uses a spray device provided with a mixing and combustion chamber and with a spray nozzle. Oxygen and fuel are fed to the chamber. The hot combustion gas, which forms at pressures close to 1 MPa, crosses the convergent-divergent nozzle, the powder material reaching hypersonic speeds (that is, higher than MACH 1). The powder material to be deposited is injected into the hot gas flow, in which it quickly melts and is accelerated at speeds of the order of 1000 m/s. Once it has impacted onto the deposition surface, the molten material quickly cools and forms a very dense and compact structure by virtue of the high kinetic energy impact.

The HVAF (High-Velocity Air Fuel) deposition technique is similar to the HVOF technique. The difference is that, in the HVAF technique, air instead of oxygen is supplied to the combustion chamber. Therefore, the temperatures in hand are lower than those of the HVOF technique. This allows greater control of the thermal alteration of the coating.

The KM (Kinetic Metallization) deposition technique is a solid-state deposition process in which metal powders are sprayed through a sonic deposition nozzle in two steps, which accelerates and triboelectrically charges the metal particles in an inert gas flow. Thermal energy is expected to be supplied to the carrier flow. In the process, the potential energy of the compressed inert gas flow and the supplied thermal energy are converted into kinetic energy of the powders. Once the particles are accelerated at high speed and electrically charged, they are directed against the deposition surface. The high-speed collision of the metal particles with such a surface causes a large deformation of the particles (approximately 80% in the direction perpendicular to the impact). This deformation results in a huge increase in the surface area of the particles. As an effect of the impact, intimate contact is formed between the particles and the deposition surface, which leads to the formation of metal bonds and a coating having a very dense and compact structure.

Advantageously, as an alternative to the three deposition techniques listed above, which share the fact of being high kinetic energy impact deposition techniques, other techniques may be used, which exploit different deposition methods, but which are able to generate coatings having a very dense and compact structure.

The combination of the HVOF or HVAF or KM or LMD or HSLC deposition technique and the chemical components used for the formation of the base layer 30 and the surface protective coating 3 allows both obtaining high bonding strength on the lower material on which they are deposited and depositing powders with high carbide content.

As mentioned above, the base layer 30 and the surface protective coating 3 cover at least one of the two braking surfaces of the braking band.

Hereafter, the term “coating” will be referred to both the whole given by the base layer 30 and the surface protective coating 3, and only the base layer 30, in the variant that does not include the surface protective coating 3 but does include carbides in the base layer 3.

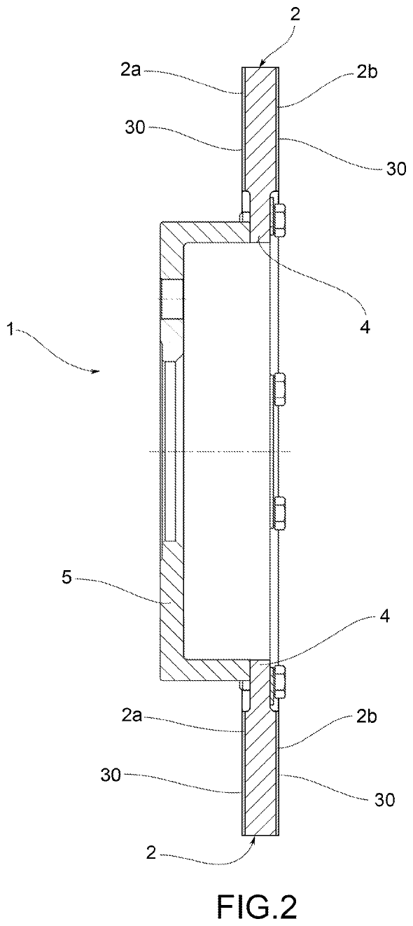

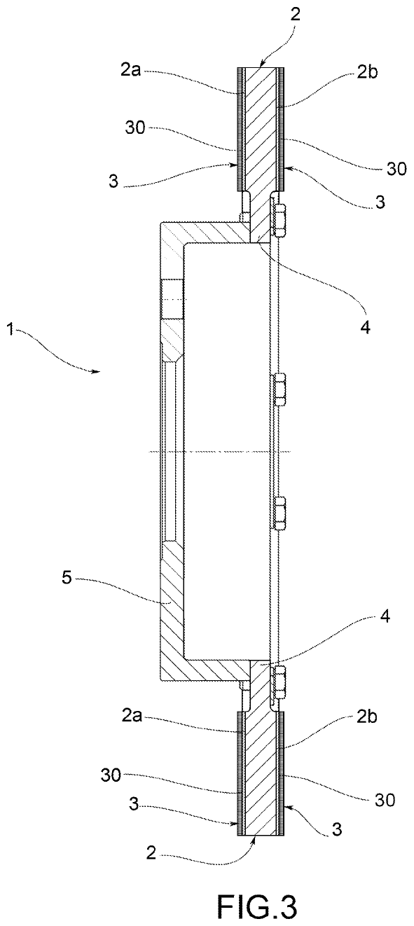

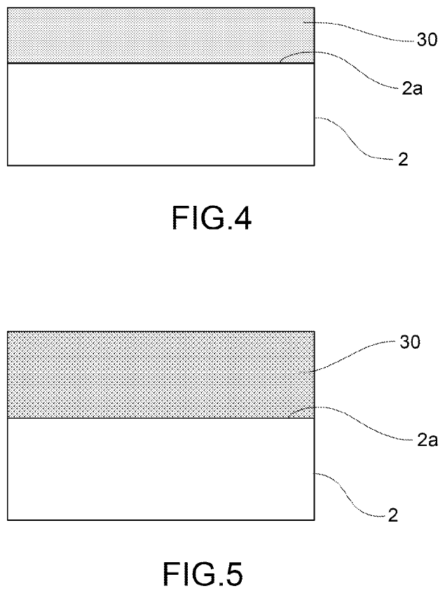

Preferably, as shown in FIG. 2 and FIG. 3, the disc 1 is provided with a coating 3, 30 which covers both braking surfaces 2a and 2b of the braking band 2.

In particular, the coating 3, 30 may cover only the braking band, on a single braking surface, or both.

According to solutions not shown in the accompanying figures, the coating 3, 30 may also extend to other parts of the disc 1 such as the annular fixing portion 4 and the bell 5, up to cover the entire surface of the disc 1. In particular, the coating 3, 30 may cover—in addition to the braking band—only the fixing portion or only the bell. The choice is substantially dictated by reasons of appearance, in order to have a uniform coloring and/or finishing on the entire disc or between some portions thereof.

Advantageously, the particle material deposition for the formation of the coating 3, 30 may be performed in a differentiated manner on the surface of the disc at least in terms of the coating thickness.

At the braking band, the coating 3, 30 may be made of the same thickness in the two opposite braking surfaces. Alternative solutions may be provided, in which the coating 3, 30 is made by differentiating the different thicknesses between the two braking surfaces of the braking band.

According to an embodiment of the method, the step b) of depositing the base layer 30 includes depositing a composition in particle form composed of steel having a nickel content at most equal to 15% or at most equal to 7.5% or at most equal to 5% or totally nickel-free steel, by means of a laser deposition technique, preferably LMD (Laser Metal D (Extreme High-Speed Laser Material Deposition), or by means of a Thermal Spray deposition technique, or by means of a Cold Spray deposition technique.

In an advantageous embodiment, in step b) the composition in particle form further comprises carbides mixed in a percentage not exceeding 50% by weight of the total particle composition.

In an advantageous embodiment, in step b) the composition in particle form, in addition to steel, also includes metal oxides or a mixture of metals and ceramic materials, preferably a mixture of aluminum oxides Al2O3, or a mixture of Al2O3 and intermetal matrix Fe—Cr, e.g., Fe28Cr.

In an advantageous embodiment, in step b) the composition in particle form, in addition to steel, also includes metal oxides or a mixture of metals and ceramic materials, preferably a mixture of aluminum oxides Al2O3, or a mixture of Al2O3 and intermetal matrix Fe—Cr, e.g., Fe28Cr, and one or more of the carbides chosen from the group comprising: tungsten carbide (WC), niobium carbide (NbC), titanium carbide (TiC), chromium carbide.

Therefore, it is apparent that, by virtue of the aforesaid variants of the method it is possible to obtain a braking band 2 in which the base layer 30 comprises a mixture of steel and metal oxides described above, or, in another variant, a mixture of steel and metal oxides and carbides described above.

The preferred variants of the braking band and the order of arrangement of the base layer 30, the intermediate layer 300 and the surface coating layer 3 are also better understood with reference to the accompanying figures.

Preferably, the step a1) of depositing the intermediate layer 300 includes depositing a composition in particle form composed of steel having a nickel content between 5% and 15%, by means of a laser deposition technique, preferably LMD (Laser Metal Deposition) or EHLA (Extreme High-Speed Laser Material Deposition), or by means of a Thermal Spray deposition technique, or by means of a Cold Spray deposition technique.

According to an advantageous variant of the method, there is included the step e1) of depositing an auxiliary ferritic-nitrocarburization layer between one of the two braking surfaces 2a, 2b of the braking band and the base layer 30, and/or between one of the two braking surfaces 2a, 2b of the braking band and the intermediate layer 300, and/or between the base layer 30 and the surface protective coating 3, and/or between the intermediate layer 300 and the base layer 30.

According to an advantageous embodiment, the method comprises step e2) of depositing an auxiliary ferroalumination layer between one of the two braking surfaces 2a, 2b of the braking band and the base layer 30, and/or between one of the two braking surfaces 2a, 2b of the braking band and the intermediate layer 300, and/or between the base layer 30 and the surface protective coating 3, and/or between the intermediate layer 300 and the base layer 30.

Preferably, the step e2) of ferroalumination comprises the steps of:

e21) immersing at least partially said braking band 2 into molten aluminum maintained at a predetermined temperature so that the molten aluminum covers at least a predetermined surface region of said braking band 2, said immersion being protracted for a predetermined period of time so as to allow the diffusion of aluminum atoms into the surface microstructure of said cast iron or steel with the consequent formation of intermetal iron-aluminum compounds at a surface layer of said braking band 2, thus generating a layer consisting of intermetal iron-aluminum compounds in said predetermined surface region of said braking band 2;
e22) extracting said braking band 2 from the molten aluminum;
e23) removing the aluminum remaining adhered to said braking band 2 after extraction, so as to expose said layer of intermetal iron-aluminum compounds on the surface.

The layer of intermetal iron-aluminum compounds exposed on the surface gives the cast iron or steel braking band 2 a higher resistance to corrosion and wear at said predetermined surface region.

Preferably, the intermetal iron-aluminum compound layer comprises FeAl3 as the main phase of iron-aluminum intermetal compounds.

According to an advantageous embodiment, the predetermined temperature at which the molten aluminum is maintained is not greater than 750° C., and is preferably between 690° C. to 710° C., and even more preferably equal to 700° C.

According to an advantageous aspect of the method, the predetermined immersion time period is fixed as a function of the desired thickness of said intermetal compound layer, and with the same temperature of the molten aluminum said thickness increasing as the immersion time increases, and with the same immersion time said thickness increasing as the temperature of the molten aluminum increases, preferably said predetermined immersion time being between 5 and 60 min, and even more preferably being equal to 30 min.

According to an advantageous aspect, before step e21) of immersion, the method comprises a step f) of decarburization of such a predetermined surface region of said braking band 2 up to a predetermined depth.

It has been experimentally found that the presence of carbon in the surface layer of the braking band subjected to diffusion penetration of aluminum atoms (induced by alumination) also leads to the formation of iron carbide in addition to intermetal compounds. The presence of iron carbide creates points of discontinuity in the intermetal compound layer, which points may trigger both corrosive phenomena and cracking. Advantageously, the surface decarburization thus allows avoiding (or at least significantly reducing) the formation of iron carbide, leading to the formation of an intermetal compound layer which is more resistant to corrosion and less prone to cracking.

Preferably, in said step f), the decarburization of said at least one predetermined surface region is carried out by an electrolytic process.

More in detail, said electrolytic process is conducted by immersing the predetermined surface region of said braking band in a molten salt bath and applying an electrical potential difference between the bath and the braking band.

In applying the electrical potential difference, the braking band is connected to a positive pole (cathode), while the aforementioned molten salt bath is connected to a negative pole (anode). Carbon, in particular in the form of graphite flakes, is oxidized to carbon dioxide by the transfer of electrons and atomic oxygen released at the anode. Carbon primarily reacts with oxygen and is eventually bound as carbon dioxide.

The oxidation of the surface of the braking band induced by the electrolytic process is not limited to the carbon present therein, but also extends to the metal matrix of the cast iron (iron), causing the formation of a surface film of metal oxide. Reversing the polarity causes the reduction in the surface film of metal oxide, which is thus returned to the original metal state.

Preferably, the aforementioned electrolytic process may thus include that, after a predetermined period of time in which the surface of the braking band has been connected to the cathode to oxidize carbon, the polarity is reversed so as to return the metal oxide film to the original metal state.

Operatively, the decarburization depth is controlled by adjusting the duration of the electrolytic process, possibly divided into several polarity reversal cycles. By increasing the duration of the decarburization process (braking band oxidation step; cathode connection), the decarburization depth increases, all other conditions being equal.

The decarburization may be carried out by alternative processes to the electrolytic process described above, such as by a laser treatment or chemical treatment.

However, the decarburization by the electrolytic process is preferred because:
it is much more efficient and quicker than a laser treatment, ensuring a more complete and uniform carbon removal in less time;
it is much more efficient (ensuring a more complete and uniform removal of carbon in less time) than a chemical treatment (e.g., with potassium permanganate) and does not leave oxidation of the cast iron metal matrix on the treated portion.

In more detail, it has been observed that at the oxidized areas on the cast iron metal matrix, the wettability of the molten aluminum is mush less, and this negatively affects the alumination process and the features of the intermetal compound layer. Also for such a reason, the electrolytic decarburization process is preferred over the alternative processes indicated above.

As already mentioned above, the growth thickness of the intermetal compound layer is mainly affected by the temperature of the molten aluminum and the time of immersion into the molten aluminum. However, it has been found that an additional factor which affects the thickness of the intermetal compound layer is the silicon content in the molten aluminum. The higher the weight content of silicon in the molten aluminum, the thinner the intermetal compound layer, with the same other conditions. Preferably, the molten aluminum has a silicon content of less than 1% by weight.

Preferably, the molten aluminum has an impurity content not exceeding 1% by weight. In particular, aluminum with a maximum purity of 99.7% by weight may be used, with the following impurities (% by weight): Si≤0.30%; Fe≤0.18%; Sr≤0.0010%; Na≤0.0025%; Li≤0.0005%; Ca≤0.0020%; P≤0.0020; Sn≤0.020%.

It was found in some cases that, although the braking band was subjected to decarburization and thus the graphite flakes were eliminated from a surface layer at which the intermetal compound layer would form, the resulting intermetal compound layer continued to include graphite flakes, as if they had never been eliminated. Such a phenomenon may be explained by the fact that the dissolution of iron in aluminum is so rapid that the decarburized layer is quickly consumed and therefore metal compounds are formed in the layer below the decarburized layer, that is, where graphite flakes are present.

In other words, the excessive solubility of iron in molten aluminum may cancel out the beneficial effects of surface decarburization of the braking band either in whole or in part.

Advantageously, step b1) of immersion in a molten aluminum bath in which iron has been dissolved may be carried out in order to slow down the dissolution of iron in the aluminum bath. Thereby, inhibiting the dissolution of iron in aluminum it is kinematically promoted the formation of FeAl3, so that intermetal compounds are allowed to form at the decarburized layer.

Preferably, the content of iron in solution in the aluminum bath does not exceed 5% by weight and even more preferably is between 3% and 5%, and quite preferably is equal to 4% by weight to ensure a significant effect of slowing down the process of dissolving iron of cast iron in aluminum.

For example, an aluminum bath with the following composition (% by weight) may be used: Al≤97%; Fe 3-5%; with the following impurities: Si≤0.30%; Fe≤0.18%; Sr≤0.0010%; Na≤0.0025%; Li≤0.0005%; Ca≤0.0020%; P≤0.0020; Sn≤0.020%.

It has been experimentally found that more porous intermetal compound d layers are obtained by performing the alumination with an aluminum bath with iron in solution, especially if the iron content is close to the solubility limit. This may be explained by a higher viscosity of the molten aluminum bath containing iron and a consequent reduction in the wettability thereof compared to cast iron.

Advantageously, in order to form an intermetal compound layer which is compact and uniform, and thus not very porous, while avoiding such a layer from developing below the decarburized layer and incorporating the graphite flakes present therein, the aforesaid step b1) of immersion is carried out in two sub-steps:
a first sub-step b11) of immersion in a first bath of molten aluminum, substantially free of iron in solution (or at most present as impurity; e.g., with iron content of less than 0.20% by weight), to obtain an initial layer consisting of intermetal iron-aluminum compounds on said predetermined surface region; and
a second sub-step b12) of immersion in a second molten aluminum bath, containing iron in solution, to increase said initial layer until a final layer consisting of intermetal iron-aluminum compounds having a predetermined thickness is obtained on said predetermined surface region.

The immersion time of said braking band in said first bath is less than the immersion time of said braking band in said second bath.

Preferably, the immersion of said braking band in said first bath is protracted for a period of time which is as short as possible but sufficient to obtain an initial layer consisting of intermetal iron-aluminum compounds having a thickness not exceeding 10 μm on said predetermined surface region. In particular, the immersion time in said first bath is between 3 and 5 minutes if the first bath is at a temperature of about 700° C. The immersion time must decrease as the bath temperature increases.

In greater detail, said thickness increases as the immersion time increases, with the same temperature of the second bath, and said thickness increases as the temperature of the second bath increases, with the same immersion time.

Advantageously, both said first molten aluminum bath and said second bath have an impurity content not exceeding 1% by weight. In particular, said two molten aluminum baths have a silicon content of less than 1% by weight.

Preferably, the content of iron in solution in the second aluminum bath does not exceed 5% by weight (the solubility limit of iron in aluminum at 700° C. is equal to 4% by weight; iron-saturated aluminum), and even more preferably is between 3% and 5%, quite preferably equal to 4% by weight. The iron content has not to be less than 3% to ensure a significant effect of slowing down the process of dissolving iron from cast iron into aluminum.

Advantageously, both said first bath and said second bath are kept at a temperature below 680° C., preferably not higher than 750° C., more preferably between 690° C. and 710° C., and even more preferably equal to 700° C.

Advantageously, the method may comprise a step of surface pre-treatment of the braking band which is carried out before said step e21) of immersion at least at said predetermined surface region. Preferably, said surface pre-treatment step comprises lapping, degreasing, sandblasting and/or chemical removal of surface oxides.

Preferably, the method comprises a step of removing a surface layer of oxides from the molten aluminum bath before said step e21) of immersion. Such a step of removing the surface oxides is conducted both if the immersion occurs in a single bath and if the immersion occurs in two successive steps in a first and a second bath.

According to a preferred embodiment of the invention, the step of removing the aluminum remaining adhered to said braking band after extraction is carried out in two sub-steps:
a first sub-step of removal is conducted on the braking band just extracted from the molten aluminum to remove the still molten aluminum remaining adhered to the braking band; and
a second sub-step of removal is conducted on the braking band extracted from the molten aluminum and cooled to remove the solidified residual aluminum remaining after said first sub-step of removal.

Preferably, the method comprises a step of quenching said braking band conducted between said first sub-step of removal and said second sub-step of removal.

Advantageously, said first sub-step of removal may be conducted by mechanical shaving of the still liquid aluminum.

Advantageously, said second sub-step of removal may be conducted by chemical removal of the solidified aluminum not mechanically removed.

Preferably, the aforesaid chemical removal is carried out by exposing the aluminum to ferric chloride for at least 4 minutes so as to cause the following reaction:

Al+FeCl3->AlCl3+Fe

The chemical removal by ferric chloride must necessarily occur after aluminum solidification. Ferric chloride boils at 315° C. and therefore may not be brought into contact with molten aluminum. Preferably, said chemical removal is thus conducted after said step of quenching.

The aforesaid steps of the method referring to ferroalumination thus allows obtaining a braking band, and thus a brake disc, with increased resistance to wear and corrosion.

It is worth noting that the intermetal iron-aluminum compound layer may comprise a plurality of intermetal compounds between iron and aluminum, in particular Fe3Al, FeAl, FeAl2, FeAl3, and Fe2Al5. The predominant intermetal phase is FeAl3 as it is thermodynamically more stable.

According to an embodiment, the method includes depositing an auxiliary ferritic-nitrocarburization layer and an auxiliary ferroalumination layer between one of the two braking surfaces 2a, 2b of the braking band and the base layer 30, and/or between one of the two braking surfaces 2a, 2b of the braking band and the intermediate layer 300, and/or between the base layer 30 and the surface protective coating 3, and/or between the intermediate layer 300 and the base layer 30.

As may be appreciated from the above description, the brake disc according to the invention allows overcoming the drawbacks introduced in the prior art.

By virtue of the combination of a base layer of steel with reduced nickel content or even totally nickel-free with a cast iron band, the brake disc 1 according to the invention is not substantially prone to the production and release of nickel particles in use.

Moreover, according to particularly advantageous variants, the addition of a surface protective coating 3 which includes or is coated with carbides allows both improving the wear resistance properties, also making up for the lack of nickel in the steel of the base layer, and providing adequate and increased mechanical strength.

In a particularly advantageous manner, the base layer 30 composed of totally nickel-free steel and 10% to 15% chromium (Cr), at most 1% silicon (Si), at most 4% manganese (Mn), between 0.16% and 0.5% carbon (C), preferably between 0.16% and 0.25% carbon (C), and the balance of iron (Fe), allows for making a nickel-free martensitic steel with less brittleness during use at high temperatures and at the same time an adequate anti-corrosion coating. Furthermore, such advantageous aspects are synergistically combined with the possibility to use a small percentage of any carbides included in the steel, thus reducing the resources required for production, while maintaining adequate coating hardness.

Advantageously, the base layer 30, preferably nickel-free, also performs a mechanical “cushioning” function for the surface protective coating 3 (anti-wear). Indeed, the base layer 30 takes an elastic behavior which allows attenuating—at least partially—the stresses impressed on the disc when in use. Thus, the base layer 30 acts as a sort of damper or cushion between the disc and the surface protective coating 3. Thereby, the direct transmission of stresses between the two parts is prevented, also reducing the risk of triggering cracks in the surface protective coating 3.

1-16. (canceled)

17. A brake disc for a disc brake, comprising a braking band provided with two opposite braking surfaces, each of which defines at least partially one of two main faces of the brake disc, the braking band being made of gray cast iron or steel;
said brake disc being provided with a base layer that covers at least one of the two opposite braking surfaces of the braking band,
wherein the base layer is composed of a steel totally free from nickel, except for impurities, and
wherein the steel of the base layer is composed of 10% to 15% chromium (Cr), at most 1% silicon (Si), at most 4% manganese (Mn), 0.16% to 0.5% carbon (C), extremes included, and iron (Fe) as a balance.

18. The brake disc of claim 17, wherein the base layer is further composed of one or more carbides included in the steel totally free from nickel.

19. The brake disc of claim 18, wherein the one or more carbides comprise at least one carbide selected from the group consisting of: tungsten carbide (WC), chromium carbide (CrC), niobium carbide (NbC), and titanium carbide (TIC).

20. The brake disc of claim 17, wherein an intermediate layer of steel free from nickel, except for impurities, is interposed between the base layer and at least one of the two opposite braking surfaces of the braking band.

21. The brake disc of claim 20, wherein the intermediate layer comprises a steel free from nickel composed of 10% to 15% chromium (Cr), at most 1% silicon (Si), at most 4% manganese (Mn), 0.16% to 0.5% carbon (C) and iron (Fe) as a balance.

22. The brake disc of claim 17, wherein an intermediate layer of steel comprising nickel is interposed between the base layer and at least one of the two opposite braking surfaces of the braking band.

23. The brake disc of claim 22, wherein the intermediate layer comprises a steel with a nickel content at most equal to 15% or equal to 15%.

24. The brake disc of claim 23, wherein the intermediate layer comprises a steel with a nickel content at most equal to 7.5% or equal to 7.5%.

25. The brake disc of claim 17, further comprising a surface protective coating that covers the base layer at least on a side of one of the two opposite braking surfaces of the braking band, said surface protective coating being disposed on a side of the base layer not facing towards one of the two opposite braking surfaces, said surface protective coating being composed of one or more carbides in particle form deposited by a thermal spray deposition technique, the thermal spray deposition technique optionally being HVOF (High Velocity Oxy-Fuel) technique, or HVAF (High Velocity Air Fuel) technique, or APS (Atmosphere Plasma Spray) technique, or by a cold spray deposition technique, optionally the cold spray deposition technique being KM (Kinetic Metallization) technique, or by a laser beam deposition technique, optionally the laser beam deposition technique being one of LMD (Laser Metal Deposition) technique, HSLC (High Speed Laser Cladding) technique, EHLA (Extreme High-speed Laser Application) technique, or TSC (Top Speed Cladding) technique.

26. The brake disc of claim 25, wherein the one or more carbides in particle form comprise one of tungsten carbide (WC), chromium carbide (CrC), niobium carbide (NbC), or titanium carbide (TiC).

27. The brake disc of claim 17, wherein a percentage of chromium in the base layer is between 11% and 14%, extremes included.

28. The brake disc of claim 25, wherein an auxiliary ferritic-nitrocarburized layer or an auxiliary ferroalumination layer is interposed between one of the two opposite braking surfaces of the braking band and the base layer, and/or between one of the two opposite braking surfaces of the braking band and an intermediate layer, and/or between the base layer and the surface protective coating, and/or between an intermediate layer and the base layer.

29. A method for making a brake disc, the method comprising the following steps:
a) preparing a brake disc comprising a braking band provided with two opposite braking surfaces, each of which defines at least partially one of two main faces of the brake disc, the braking band being made of gray cast iron or steel; and
b) depositing a base layer composed of steel totally free from nickel, except for impurities, and from 10% to 15% chromium (Cr), at most 1% silicon (Si), at most 4% manganese (Mn), from 0.16% to 0.5% carbon (C) and iron (Fe) as a balance.

30. The method of claim 29, wherein step b) of depositing the base layer provides depositing a composition in particle form composed of nickel-free steel, by a laser deposition technique, or by a thermal spray deposition technique, or by a cold spray deposition technique.

31. The method of claim 30, wherein the laser deposition technique is LMD (Laser Metal Deposition) technique or EHLA (Extreme High-speed Laser Application) technique.

32. The method of claim 29, further comprising a step c) of depositing over said base layer a material in particle form composed of one of tungsten carbide (WC), niobium carbide (NbC), titanium carbide (Tic), or chromium carbide (CrC) by a thermal spray deposition technique, optionally the thermal spray deposition technique being one of HVOF (High-Velocity Oxy-Fuel) technique, HVAF (High-Velocity Air Fuel) technique, or APS (Atmosphere Plasma Spray) technique, or by a cold spray deposition technique, optionally the cold spray deposition technique being KM (Kinetic Metallization) technique, or by a laser beam deposition technique, optionally the laser beam deposition technique being one of LMD (Laser Metal Deposition) technique, HSLC (High-speed Laser Cladding) technique, EHLA (Extreme High-speed Laser Application) technique, or TSC (Top Speed Cladding) technique, forming a surface protective coating that covers the base layer.

33. The method of claim 32, wherein the surface protective coating covers the base layer at least for an entire surface of one of the two opposite braking surfaces of the braking band.

34. The method of claim 29, wherein after step a) and before step b), the method comprises a step of:
a1) depositing on at least one of the two opposite braking surfaces, an intermediate layer composed of steel free from nickel, except for impurities, and 10% to 15% chromium (Cr), at most 1% silicon (Si), at most 4% manganese (Mn), 0.16% to 0.5% carbon (C) and iron (Fe) as a balance.
